(19) United States
(12) Patent Application Publication
(10) Pub. No.: US 2024/0282914 A1
(43) Pub. Date: Aug. 22, 2024

(54) HIGH-ENTROPY HYDROGEN STORAGE ALLOY, NEGATIVE ELECTRODE FOR ALKALINE STORAGE BATTERY, AND ALKALINE STORAGE BATTERY

(71) Applicant: AICHI STEEL CORPORATION, Tokai-shi (JP)

(72) Inventors: Tomoyuki TAKEMOTO, Aichi (JP); Toshiaki FUKAGAWA, Aichi (JP); Yasuyuki SAITOU, Aichi (JP); Akihiro MATSUYAMA, Aichi (JP)

(73) Assignee: AICHI STEEL CORPORATION, Tokai-shi (JP)

(21) Appl. No.: 18/563,998

(22) PCT Filed: May 25, 2022
(86) PCT No.: PCT/JP2022/021445

§ 371 Date: Nov. 24, 2023

(30) Foreign Application Priority Data
May 27, 2021 (JP) 2021-089220

(51) Int. Cl. H01M 4/24; H01M 10/28

(52) U.S. Cl. CPC H01M 4/242; H01M 10/28

(57) ABSTRACT

A high-entropy hydrogen storage alloy includes Ti: 5 atom % or more and 35 atom % or less, Zr: 5 atom % or more and 35 atom % or less, Ni: 5 atom % or more and 35 atom % or less, Cr: 5 atom % or more and 35 atom % or less, and Mn: 5 atom % or more and 35 atom % or less, in which a mixing entropy ΔSₘᵢₓ represented by the following formula (1) is 1.5 R or more. The crystal structure of a main phase is a C14 type.

ΔSₘᵢₓ=−RΣxᵢ ln(xᵢ) (1)
(wherein R in the formula (1) represents the gas constant, and xᵢ represents a molar fraction of an individual element contained in the high-entropy hydrogen storage alloy.)

### TECHNICAL FIELD

The present invention relates to a high-entropy hydrogen storage alloy, a negative electrode for an alkaline storage battery, and an alkaline storage battery.

### BACKGROUND ART

In the past, a hydrogen storage alloy is often used as a negative electrode active material for use in an alkaline storage battery such as a nickel-metal hydride battery. In recent years, there has been developed a technology of using a hydrogen storage alloy for storing hydrogen in a hydrogen station for supplying hydrogen to a fuel cell vehicle or the like.

The hydrogen storage alloy is an alloy composed of an element A having a high affinity with hydrogen and an element B having a low affinity with hydrogen, and an AB₅ type alloy, an AB₂ type alloy, an AB type alloy, and the like are known. For example, a hydrogen storage alloy of the AB₅ type containing a rare earth mixed metal has already been put into practical use as a negative electrode active material for a nickel-metal hydride battery (Patent Literature 1).

In addition, for example, Non Patent Literature 1 describes a ZrNi alloy having an AB type composition (Non Patent Literature 1).

### PRIOR ART LITERATURE

### Patent Literature

Patent Literature 1: JP-A-2012-167375

### Non Patent Literature

Non Patent Literature 1: Dantzer P, Millet P, Flanagan TB. Thermodynamic Characterization of Hydride Phase Gas Growth in ZrNi—H2. Metall Mater Trans A. 2001; 32A: 29-38.

### SUMMARY OF INVENTION

### Problems to be Solved by Invention

However, the hydrogen storage capacity of the hydrogen storage alloy of Patent Literature 1 is about 1.2 mass %, and from the viewpoint of improving performance such as an energy density of an alkaline storage battery and increasing a storage amount of hydrogen in a hydrogen station, there is a demand for a hydrogen storage alloy having a hydrogen storage capacity higher than that of the hydrogen storage alloy in Patent Literature 1. In addition, the rare earth mixed metal contained in the hydrogen storage alloy in Patent Literature 1 is relatively expensive and its production regions are unevenly located, therefore, cost fluctuation occurs easily in response to the changes in social conditions and so on.

The ZrNi alloy described in Non Patent Literature 1 can easily realize a hydrogen storage capacity higher as compared with that of the hydrogen storage alloy in Patent Literature 1. However, the ZrNi alloy reacts with absorbed hydrogen to thereby easily produce a hydride having high chemical stability such as ZrNiH₃ or ZrNiH. For this reason, there is a problem that the ZrNi alloy is unlikely to desorb the absorbed hydrogen to the outside and is not suitable for practical use. In addition, Zr and Ni are relatively expensive, and thus a reduction of usage of Zr and Ni has been demanded.

The present invention has been made in view of such circumstances, and is directed to providing a hydrogen storage alloy for which a raw material cost can be easily reduced, a negative electrode for an alkaline storage battery using the hydrogen storage alloy, and an alkaline storage battery.

### Means for Solving Problems

An aspect of the present invention is a high-entropy hydrogen storage alloy including Ti (titanium): 5 atom % or more and 35 atom % or less, Zr (zirconium): 5 atom % or more and 35 atom % or less, Ni (nickel): 5 atom % or more and 35 atom % or less, Cr (chromium): 5 atom % or more and 35 atom % or less, and Mn (manganese): 5 atom % or more and 35 atom % or less, wherein
a mixing entropy ΔSₘᵢₓ represented by the following formula (1) is 1.5 R or more, and
a crystal structure of a main phase is a C14 type.

$$\begin{matrix}[ Math . 1 ] & \\ Δ {S}_{m i x} = - R {\sum }_{i = T i , Zr , Ni , Cr , Mn} {x}_{i} ln {x}_{i} & ( 1 )\end{matrix}$$

Here, R in the formula (1) represents the gas constant, and xᵢ is a molar fraction of each element contained in the high-entropy hydrogen storage alloy.

### Effects of Invention

By setting the contents of Ti, Zr, Ni, Cr, and Mn in the high-entropy hydrogen storage alloy (hereinafter, referred to as a “hydrogen storage alloy”) within the specific ranges described above, a high mixing entropy ΔSₘᵢₓ of 1.5 times or more the gas constant can be realized and the main phase of the alloy can have a C14 type crystal structure. The hydrogen storage alloy having such a chemical composition and such a crystal structure can repeatedly perform absorption and desorption of hydrogen.

In addition, all the elements contained in the hydrogen storage alloy are relatively low in uneven distribution of production regions. Furthermore, when the content of each element is within the specific range described above, a crystal phase having a C14 type crystal structure can be formed in the hydrogen storage alloy, therefore, usage of Zr and Ni, which are relatively expensive among the five kinds of elements described above, can be easily reduced. Accordingly, cost reduction in the raw material of the hydrogen storage alloy can be easily achieved.

As mentioned above, the above aspect makes it possible to provide a hydrogen storage alloy for which the raw material cost is easily reduced.

### BRIEF DESCRIPTION OF DRAWINGS

FIG. 1 is an explanatory diagram showing X-ray diffraction patterns of an alloy A1, an alloy A5, and alloys A8 to A11 in Example 1.

FIG. 2 is an explanatory diagram showing X-ray diffraction patterns of alloys A12 to A16 in Example 1.

FIG. 3 is an explanatory diagram showing a pressure-composition isotherm of the alloy A9 in Example 1.

FIG. 4 is a partial cross-sectional view illustrating a main part of a negative electrode for an alkaline storage battery in Example 2.

FIG. 5 is an explanatory diagram showing discharge capacity ratios at respective current densities of a test specimen B9 and a test specimen B9A in Example 3.

FIG. 6 is an explanatory diagram showing a relationship between a discharge capacity ratio and a constituent ratio of a subphase, of a test specimen subjected to activation treatment in Example 3.

FIG. 7 is an explanatory diagram showing a relationship between a capacity retention rate and a constituent ratio of a subphase, of each test specimen in Example 4.

### MODE FOR CARRYING OUT INVENTION

### (Hydrogen Storage Alloy)

The hydrogen storage alloy is a quinary alloy composed of Ti and Zr as the element A and Ni, Cr, and Mn as the element B. The hydrogen storage alloy has a chemical composition in which the content of each element described above is 5 atom % or more and 35 atom % or less and a mixing entropy ΔSₘᵢₓ represented by the following formula (1) is 1.5 R or more.

$$\begin{matrix}[ Math . 2 ] & \\ Δ {S}_{mix} = - R {\sum }_{i = Ti , Zr , Ni , Cr , Mn} {x}_{i} ln {x}_{i} & ( 1 )\end{matrix}$$

Here, R in the formula (1) represents the gas constant, and xᵢ represents a molar fraction of each element contained in the hydrogen storage alloy.

By specifying the chemical composition of the hydrogen storage alloy such that the content of each element and the mixing entropy ΔSₘᵢₓ fall within the above-mentioned ranges, the main phase of the hydrogen storage alloy can have a C14 type crystal structure. Note that the “C14 type crystal structure” is identical to the hexagonal MgZn₂ type structure clarified in, for example, “Metal vol. 80 (2010), No. 7, p. 32”.

The Ti content in the hydrogen storage alloy is preferably 10 atom % or more and 33 atom % or less, and more preferably 13 atom % or more and 28 atom % or less. In this case, a crystal phase having the C14 type crystal structure is more easily formed in the hydrogen storage alloy. From the same viewpoint, the Zr content in the hydrogen storage alloy is preferably 10 atom % or more and 30 atom % or less, and more preferably 13 atom % or more and 25 atom % or less. The Ni content in the hydrogen storage alloy is preferably 10 atom % or more and 33 atom % or less, and more preferably 15 atom % or more and 30 atom % or less. The Cr content in the hydrogen storage alloy is preferably 10 atom % or more and 30 atom % or less, and more preferably 15 atom % or more and 25 atom % or less. The Mn content in the hydrogen storage alloy is preferably 10 atom % or more and 30 atom % or less, and more preferably 13 atom % or more and 25 atom % or less.

More specifically, the hydrogen storage alloy may have a chemical composition composed of Ti: 10 atom % or more and 33 atom % or less, Zr: 10 atom % or more and 30 atom % or less, Ni: 10 atom % or more and 33 atom % or less, Cr: 10 atom % or more and 30 atom % or less, and Mn: 10 atom % or more and 30 atom % or less. Alternatively, the hydrogen storage alloy may have a chemical composition composed of Ti: 13 atom % or more and 28 atom % or less, Zr: 15 atom % or more and 25 atom % or less, Ni: 15 atom % or more and 30 atom % or less, Cr: 10 atom % or more and 30 atom % or less, and Mn: 13 atom % or more and 25 atom % or less.

The “main phase” described above means a crystal phase of which the constituent ratio is the highest among crystal phases contained in the hydrogen storage alloy. For example, the hydrogen storage alloy may be composed only of a crystal phase having the C14 type crystal structure. Alternatively, the hydrogen storage alloy may be composed of a main phase having the C14 type crystal structure and one or two or more kinds of crystal phases having other crystal structures. When the hydrogen storage alloy contains a plurality of kinds of crystal phases, which crystal phase is the main phase can be determined on the basis of the X-ray diffraction chart of the hydrogen storage alloy. More specifically, by performing Rietvelt analysis on the X-ray diffraction chart of the hydrogen storage alloy, the mass ratio of each crystal phase present in the hydrogen storage alloy can be estimated.

In the hydrogen storage alloy, the higher the constituent ratio of the main phase is made, the higher the hydrogen storage capacity can be made. From this viewpoint, the constituent ratio of the main phase is preferably 75 mass % or more, and more preferably 80 mass % or more. By raising the constituent ratio of the main phase, a hydrogen storage capacity can be easily made higher than that of a typical AB₅ type rare earth nickel-based hydrogen storage alloy. In addition, when such a high-entropy hydrogen storage alloy is used as an active material of a negative electrode for use in an alkaline storage battery, a high discharge capacity can be easily realized.

The high-entropy hydrogen storage alloy may include a subphase having a B2 type crystal structure. In this case, the constituent ratio of the subphase having the B2 type crystal structure is preferably more than 0 mass % and 20 mass % or less. By setting the constituent ratio of the subphase having the B2 type crystal structure within the abovementioned range, the effect of raising the hydrogen storage capacity can be more reliably obtained. In addition, in this case, hydrogen absorbed in the high-entropy hydrogen storage alloy is easily desorbed to the outside of the hydrogen storage alloy. Thus, such a hydrogen storage alloy is suitable as, for example, a hydrogen storage material in a hydrogen station and an active material of a negative electrode for use in an alkaline storage battery.

From the viewpoint of more reliably obtaining the above-described operational advantage, the constituent ratio of the subphase having the B2 type crystal structure in the high-entropy hydrogen storage alloy is more preferably 0.5 mass % or more, still more preferably 1.0 mass % or more, particularly preferably 1.5 mass % or more, and most preferably 2.0 mass % or more. On the other hand, from the viewpoint of further raising the hydrogen storage capacity of the high-entropy hydrogen storage alloy, the constituent ratio of the subphase having the B2 type crystal structure in the high-entropy hydrogen storage alloy is more preferably 17 mass % or less, still more preferably 15 mass % or less, particularly preferably less than 10 mass %, and most preferably 5.0 mass % or less.

More specifically, the high-entropy hydrogen storage alloy preferably has, for example, a chemical composition including Ti: 15 atom % or more and 25 atom % or less, Zr: 15 atom % or more and 25 atom % or less, Ni: 15 atom % or more and 33 atom % or less, Cr: 15 atom % or more and 30 atom % or less, and Mn: 10 atom % or more and 25 atom % or less, the mixing entropy ΔSₘᵢₓ represented by the above formula (1) is preferably 1.5 R or more, the crystal structure of the main phase is preferably the C14 type, and the subphase having the B2 type crystal structure is preferably contained in an amount of more than 0 mass % and less than 10 mass %. Such a high-entropy hydrogen storage alloy has a high hydrogen storage capacity and can easily desorb hydrogen absorbed in the hydrogen storage alloy to the outside, therefore it is suitable as, for example, a hydrogen storage material in a hydrogen station. From the same viewpoint, the high-entropy hydrogen storage alloy preferably has, for example, a chemical composition including Ti: 15 atom % or more and 25 atom % or less, Zr: 15 atom % or more and 25 atom % or less, Ni: 15 atom % or more and 33 atom % or less, Cr: 15 atom % or more and 30 atom % or less, and Mn: 10 atom % or more and 25 atom % or less, the mixing entropy ΔSₘᵢₓ represented by the above formula (1) is preferably 1.5 R or more, the crystal structure of the main phase is the C14 type, and the subphase having the B2 type crystal structure is more preferably contained in an amount of more than 0.5 mass % and 5 mass % or less.

In the high-entropy hydrogen storage alloy, the constituent ratio of the subphase having the B2 type crystal structure may be 10 mass % or more and 20 mass % or less. When such a hydrogen storage alloy is used as an active material of a negative electrode for use in an alkaline storage battery, the discharge capacity can be further increased. Furthermore, in this case, it is possible to curtail decrease in the discharge capacity when a charge and discharge cycle is repeated, and to maintain a high discharge capacity for a long period of time. Accordingly, the hydrogen storage alloy in which the constituent ratio of the subphase having the B2 type crystal structure is within the specific range described above is suitable as, for example, a negative electrode active material of an alkaline storage battery. From the viewpoint of further increasing the discharge capacity of the alkaline storage battery while curtailing the decrease in the discharge capacity when the charge and discharge cycle is repeated, the constituent ratio of the subphase having the B2 type crystal structure in the high-entropy hydrogen storage alloy is preferably 10 mass % or more and 18 mass % or less, and more preferably 10 mass % or more and 16 mass % or less.

In addition to the above-described operational advantage, from the viewpoint of further improving discharge rate properties and curtailing decrease in the discharge capacity in a case of discharging at a high current density the constituent ratio of the subphase having the B2 type crystal structure in the high-entropy hydrogen storage alloy is preferably 10 mass % or more and 15 mass % or less.

More specifically, the high-entropy hydrogen storage alloy preferably has, for example, a chemical composition including Ti: 15 atom % or more and 25 atom % or less, Zr: 15 atom % or more and 25 atom % or less, Ni: 15 atom % or more and 30 atom % or less, Cr: 15 atom % or more and 30 atom % or less, and Mn: 10 atom % or more and 25 atom % or less, the mixing entropy ΔSₘᵢₓ represented by the above formula (1) is preferably 1.5 R or more, the crystal structure of the main phase is preferably the C14 type, and the subphase having the B2 type crystal structure is preferably contained in an amount of 10 mass % or more and 20 mass % or less. Such a high-entropy hydrogen storage alloy can improve a discharge capacity and charge and discharge cycle properties when used as an active material of a negative electrode in an alkaline storage battery, and thus the high-entropy hydrogen storage alloy is suitable as a negative electrode active material for an alkaline storage battery. From the same viewpoint, the high-entropy hydrogen storage alloy preferably has, for example, a chemical composition including Ti: 15 atom % or more and 25 atom % or less, Zr: 15 atom % or more and 25 atom % or less, Ni: 25 atom % or more and 30 atom % or less, Cr: 15 atom % or more and 30 atom % or less, and Mn: 10 atom % or more and 25 atom % or less, the mixing entropy ΔSₘᵢₓ represented by the above formula (1) is preferably 1.5 R or more, the crystal structure of the main phase is preferably the C14 type, and the subphase having the B2 type crystal structure is preferably contained in an amount of 10 mass % or more and 16 mass % or less.

Furthermore, from the viewpoint of improving the discharge capacity and the charge and discharge cycle properties and further improving the discharge rate properties, the high-entropy hydrogen storage alloy preferably has, for example, a chemical composition including Ti: 15 atom % or more and 25 atom % or less, Zr: 15 atom % or more and 25 atom % or less, Ni: 25 atom % or more and 30 atom % or less, Cr: 15 atom % or more and 30 atom % or less, and Mn: 10 atom % or more and 25 atom % or less, the mixing entropy ΔSₘᵢₓ represented by the above formula (1) is preferably 1.5 R or more, the crystal structure of the main phase is the C14 type, and the subphase having the B2 type crystal structure is preferably contained in an amount of 10 mass % or more and 15 mass % or less.

The hydrogen storage alloy has a high mixing entropy of 1.5 R or more. An alloy having such a high mixing entropy is called a high-entropy alloy, and has characteristics different from those of a typical alloy. For example, in the hydrogen storage alloy, the arrangement of Ti, Zr, Ni, Cr, and Mn in the crystal structure is disordered due to the high mixing entropy ΔSₘᵢₓ. The hydrogen storage alloy having such a distinctive atomic arrangement has a high hydrogen storage capacity and can easily desorb the stored hydrogen even in a room temperature environment.

In addition, the hydrogen storage alloy preferably has a static hydriding property in which a plateau pressure in hydrogen absorption process and a plateau pressure in hydrogen desorption process in a pressure-composition isotherm acquired under an environment of a temperature of 30° C. are respectively 0.01 MPa or more and 0.50 MPa or less. When the hydrogen storage alloy having such property is used as a hydrogen storage material in a hydrogen station or an active material of a negative electrode for an alkaline storage battery, the hydrogen pressure in the hydrogen absorption process or the hydrogen desorption process can be controlled by a simple method. Thus, such a hydrogen storage alloy is more excellent in practical use.

In addition, the hydrogen storage alloy more preferably has a static hydriding property in which a ratio of the plateau pressure in the hydrogen absorption process to the plateau pressure in the hydrogen desorption process in a pressure-composition isotherm acquired under an environment of a temperature of 30° C. is 0.5 times or more and 3.0 times or less. By using the hydrogen storage alloy having such a small hysteresis as a hydrogen storage material or the like in a hydrogen station, an amount of hydrogen supplied to the hydrogen storage alloy in the hydrogen absorption process and an amount of hydrogen desorb from the hydrogen storage alloy in the hydrogen desorption process can be controlled by the same method. Thus, such a hydrogen storage alloy is more excellent in practical use.

The chemical composition of the hydrogen storage alloy substantially contains no Fe (iron). That is, the Fe content in the hydrogen storage alloy is equal to or less than the content deemed as inevitable impurities. Fe may unfavorably form Fe(OH)₃ when it comes into contact with an alkaline aqueous solution such as an electrolyte in an alkaline storage battery. Fe(OH)₃ is an insulator, and thus when a hydrogen storage alloy containing Fe is used as an active material of a negative electrode for an alkaline storage battery, the electron conductivity of the active material may decrease, leading to deterioration of discharge rate properties. On the other hand, the hydrogen storage alloy described above contains no Fe, and thus no Fe(OH)₃ is formed even when the hydrogen storage alloy and the alkaline aqueous solution come into contact with each other. Accordingly, the hydrogen storage alloy is also suitable as an active material of a negative electrode for an alkaline storage battery.

In addition to Ti, Zr, Ni, Cr, and Mn as essential elements, the hydrogen storage alloy may contain inevitable impurities inevitably mixed in the production process. Contents of these inevitable impurities may be 0.2 atom % or less for each element and 2.0 atom % or less in total.

### (Method for Producing Hydrogen Storage Alloy)

The hydrogen storage alloy can be easily prepared, for example, by simply casting an alloy having the specific chemical composition. The method for melting the hydrogen storage alloy is not particularly limited, and for example, various melting furnaces such as a vacuum high frequency melting furnace can be used. As a method for casting the hydrogen storage alloy, various methods, for example, a strip casting method, and so on can be adopted.

In some cases, the hydrogen storage alloy immediately after casted may have defects such as vacancies and lattice distortion generated in a solidification process, and/or dislocations. The defects and dislocations in the hydrogen storage alloy cause a decrease in the hydrogen storage capacity. Therefore, reduction of the defects and dislocations in the hydrogen storage alloy can make the hydrogen storage capacity still larger.

In order to remove defects and dislocations in the hydrogen storage alloy, it is preferable to heat the hydrogen storage alloy after casting to 1000° C. or less in an inert gas atmosphere. When heating is performed under the specific conditions mentioned above, it is possible to remove defects and dislocations present inside the hydrogen storage alloy while maintaining the specific crystal structure. As a result, the hydrogen storage capacity of the hydrogen storage alloy can be made still larger.

### (Negative Electrode for Alkaline Storage Battery)

The negative electrode for an alkaline storage battery prepared using the hydrogen storage alloy may have, for example, the following configuration. That is, the negative electrode for an alkaline storage battery includes a current collector including a conductor, a binder, and a powdery active material held by the current collector via the binder, and
the active material includes
a core portion composed of the hydrogen storage alloy, and
a surface layer containing a hydroxide of Ni and existing on a surface of the core portion.

In the negative electrode, as the current collector, for example, conductors of various aspects such as a metal foil, a punching metal, an expanded metal, and a metal mesh can be applied.

The binder is interposed between the current collector and the active material to thereby act to hold the active material on the current collector. As the binder, for example, polyvinyl alcohol etc. can be used. In addition, the binder may contain any known additive such as a thickener as necessary.

The negative electrode may contain a known conductive agent or conductive auxiliary agent such as a Cu (copper) powder or a Ni powder as necessary. The conductive agent and the conductive auxiliary agent are held by the current collector via the binder as with the active material.

The core portion of the active material is composed of the hydrogen storage alloy. As described above, the hydrogen storage alloy can absorb and desorb hydrogen, and can be thus applied to an active material of a negative electrode for an alkaline storage battery. That is, the negative electrode can absorb a large amount of hydrogen in the core portion of the active material at the time of charging. In addition, the negative electrode can easily desorb hydrogen absorbed in the core portion from the core portion to the outside at the time of discharge.

The surface layer containing a hydroxide of Ni is present on the surface of the core portion. In addition to the hydroxide of Ni, the surface layer may contain an oxide of Ni and an insulating compound such as ZrO₂ or TiO₂ remaining after activation treatment described below. The surface layer may be composed of fine particles containing a hydroxide of Ni. When the surface layer is formed on the surface of the core portion, the discharge rate properties of the negative electrode can be further improved, and a difference between the discharge capacity of the alkaline storage battery in a case of being discharged at a high discharge rate and the discharge capacity of the alkaline storage battery in a case of being discharged at a low discharge rate can be further reduced.

### (Method for Producing Negative Electrode for Alkaline Storage Battery)

In producing the negative electrode for an alkaline storage battery, first, a hydrogen storage alloy is cast by the method described above. The hydrogen storage alloy is pulverized to prepare a powdery active material. On the surface of the active material thus obtained, an insulating compound such as ZrO₂ or TiO₂ formed by contact with the atmosphere or the like exists. Next, the active material is mixed with a binder and so on to prepare a negative electrode mixture. Then, the negative electrode mixture is applied to the current collector and then dried, whereby the active material can be held on the current collector.

Thereafter, the active material held on the current collector is boiled in a strong alkaline aqueous solution to perform activation treatment. As the strong alkaline aqueous solution for use in the activation treatment, for example, an aqueous solution having a temperature of 105° C. or higher and a pH of 14 or higher can be used. By performing the activation treatment on the active material, the insulating compound present on the surface of the active material can be removed, and the Ni atom present on the surface of the active material can be made into a hydroxide. Consequently, the surface layer is formed on the surface of the active material, so that the negative electrode can be obtained.

In the method for producing the negative electrode, performing the activation treatment makes it possible to reduce an adverse effect caused by an insulating compound such as ZrO₂ or TiO₂ present on the surface of the active material. It is considered that this can improve the discharge capacity and discharge rate properties of the negative electrode.

### EXAMPLES

### Example 1

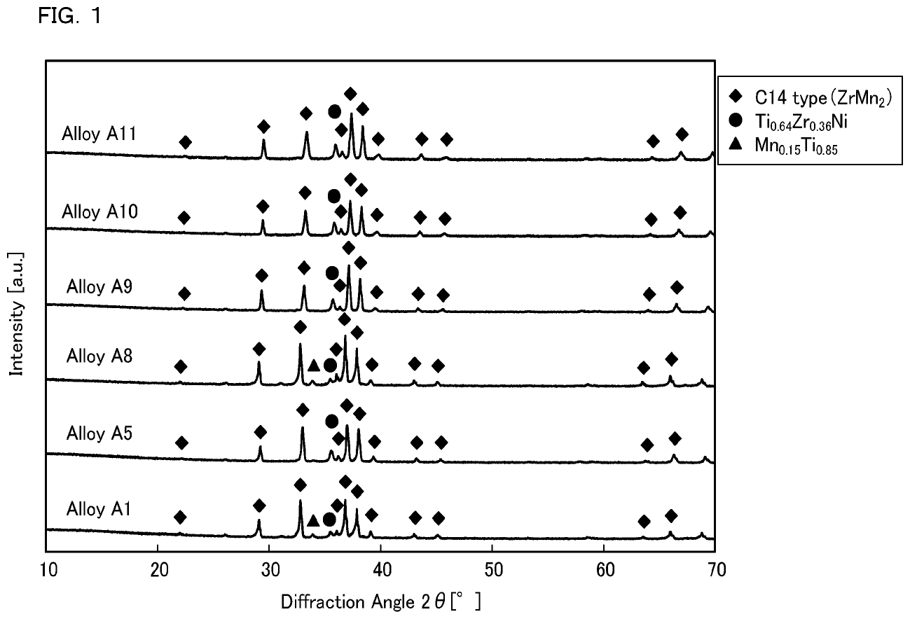

An example of the hydrogen storage alloy will be described with reference to FIGS. 1 to 3. A hydrogen storage alloy of the present Example has a chemical composition including Ti: 5 atom % or more and 35 atom % or less, Zr: 5 atom % or more and 35 atom % or less, Ni: 5 atom % or more and 35 atom % or less, Cr: 5 atom % or more and 35 atom % or less, and Mn: 5 atom % or more and 35 atom % or less, in which a mixing entropy ΔSₘᵢₓ represented by the following formula (1) is 1.5 R or more. In addition, the crystal structure of the main phase of the hydrogen storage alloy is a C14 type.

$$\begin{matrix}[ Math . 3 ] & \\ Δ {S}_{mix} = - R {\sum }_{i = Ti , Zr , Ni , Cr , Mn} {x}_{i} ln {x}_{i} & ( 1 )\end{matrix}$$

Here, R in the formula (1) represents the gas constant, and xᵢ represents a molar fraction of each element contained in the hydrogen storage alloy. Hereinafter, a method for producing the hydrogen storage alloy of the present example will be described in detail.

### (Preparation of Hydrogen Storage Alloy)

First, using an arc melting furnace, Ti (powder, manufactured by Kojundo Chemical Laboratory Co., Ltd., purity: 99.9%), Zr (sponge, manufactured by Kojundo Chemical Laboratory Co., Ltd., purity: 98.0%), Ni (powder, manufactured by Kojundo Chemical Laboratory Co., Ltd., purity: 99.9%), Cr (powder, manufactured by Kojundo Chemical Laboratory Co., Ltd., purity: 99.0%), and Mn (flake, manufactured by Kojundo Chemical Laboratory Co., Ltd., purity: 99.9%) were mixed at desired ratios and then melted to prepare an ingot of a hydrogen storage alloy. In this regard, a vacuum high-frequency melting furnace may be used for melting Ti and the like. A strip casting method may be adopted for casting the hydrogen storage alloy. In addition, the ingot or the like thus casted may be subjected to heat treatment such as homogenization treatment as necessary.

Next, the obtained test specimen was divided into two equal parts using a wet cutting machine, and one piece of the ingot was used to measure the specific gravity and observe the structure. On the other hand, the other piece of the ingot was coarsely pulverized with a tungsten carbide mortar to obtain a powder. This powder was hydrogenated and pulverized, and then hydrogen was desorbed from the powder to refine the powder. Then, the refined powder was sieved to obtain a powder having a diameter of 20 to 40 μm.

As described above, hydrogen storage alloys (alloys A1 to A16) having a chemical composition shown in Table 1 were prepared. The content of each element shown in Table 1 is a value measured by inductively coupled plasma emission spectrometry (ICP). For the analysis of the chemical composition, a high frequency plasma emission spectrometer (“ICPV-1017” manufactured by Shimadzu Corporation) was used.

### (Characterization of Hydrogen Storage Alloy)

Next, crystal structure analysis and evaluation of static hydriding property were performed on the alloys A1 to A16 obtained as described above.

### [Crystal Structure Analysis]

Powder X-ray diffraction was performed using an X-ray diffractometer (“SmartLab (registered trademark)” manufactured by Rigaku Corporation) to acquire an X-ray diffraction pattern of each alloy. Then, crystal phases contained in each alloy were identified on the basis of the obtained X-ray diffraction pattern, and Rietvelt analysis was performed on the X-ray diffraction pattern to estimate the constituent ratios of the crystal phases in each alloy. The powder X-ray diffraction was performed using CuKα rays, and the output of an X-ray tube was set to be 40 kV and 40 mA. The crystal structure analysis and the Rietvelt analysis were performed using powder X-ray analysis software (“PDXL” manufactured by Rigaku Corporation).

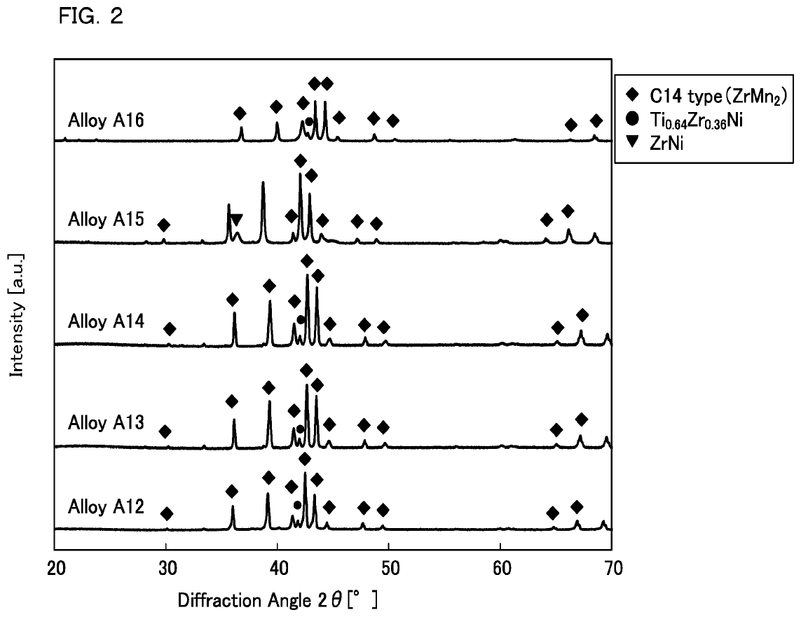

FIG. 1 shows X-ray diffraction patterns of the alloy A1, the alloy A5, and the alloys A8 to A11 as examples of the X-ray diffraction pattern. FIG. 2 shows X-ray diffraction patterns of the alloys A12 to A16. In FIGS. 1 and 2, the vertical axis represents a diffraction intensity (relative intensity), and the horizontal axis represents a diffraction angle 2θ(°).

As a result of collating diffraction peaks appearing in the X-ray diffraction patterns with a database, it was estimated that the main phases of the alloys A1 to A16 had a crystal structure of ZrMn₂ having the C14 type crystal structure or a crystal structure in which a Zr atom and/or an Mn atom in ZrMn₂ were/was substituted with other atom(s), as shown in Table 2. In addition, in some alloys, in addition to ZrMn₂ as the main phase, Ti_{0.64}Zr_{0.36}Ni and Mn_{0.15}Ti_{0.85} having the B2 type crystal structure and ZrNi having a B33 type crystal structure were formed as a second phase.

Table 2 shows the mass ratio between the main phase and the second phase in each alloy estimated by the Rietvelt analysis. In the Rietvelt analysis, fitting of the X-ray diffraction pattern was performed assuming that the main phase was Zr_{0.5}Ti_{0.5}Mn₂ having the C14 type crystal structure and the second phase was TiNi having the B2 type crystal structure or ZrNi having the B33 type crystal structure. When the lattice constant and the lattice volume in the main phase of each alloy were calculated by a whole powder pattern fitting (WPPF) method, the lattice constant and the lattice volume of the main phase of each alloy were as shown in Table 2.

### [Static Hydriding Property]

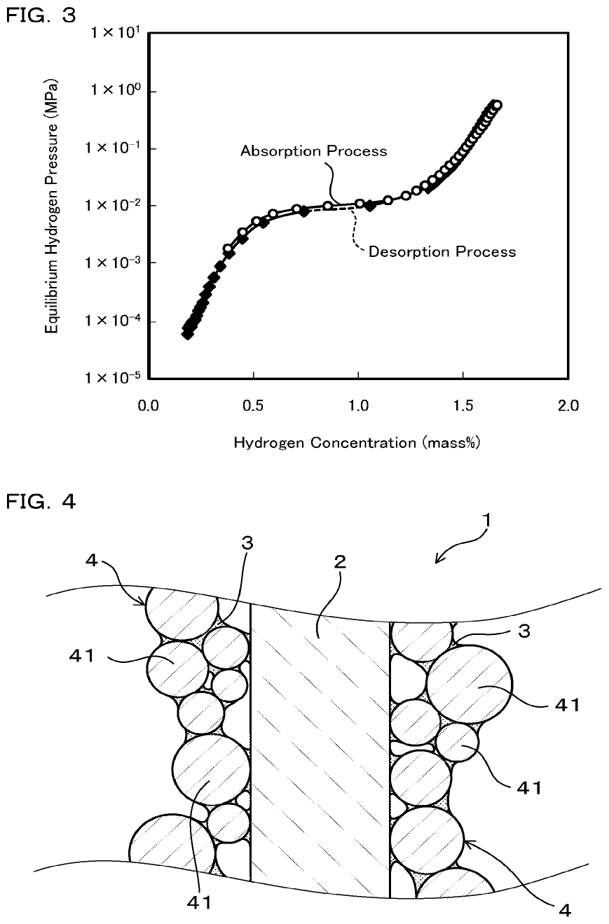

A pressure-composition isotherm at a temperature of 30° C. was acquired for the alloys A1 to A16 using a Pressure-Composition-Temperature (PCT) characteristic measuring apparatus (manufactured by Suzuki Shokan Co., Ltd.). As an example of the static hydrogen hydriding property, the pressure-composition isotherm of the alloy A9 is shown in FIG. 3. In FIG. 3, the vertical axis represents an equilibrium hydrogen pressure (MPa), and the horizontal axis represents a hydrogen concentration (mass %).

The hydrogen storage capacity at a pressure of 0.8 MPa was read from the pressure-composition isotherm in the hydrogen absorption process of each alloy, and this value was taken as the maximum hydrogen storage capacity. In addition, a plateau pressure was determined from the pressure-composition isotherm in the hydrogen absorption process or the hydrogen desorption process of each alloy by the following method. That is, first, a linear region having a relatively small inclination and substantially parallel to the horizontal axis on the pressure-composition isotherm was specified, and this region was taken as a plateau region. Next, equilibrium hydrogen pressures in the plateau region were arithmetically averaged, and the obtained value was taken as the plateau pressure. As for each alloy, the maximum hydrogen storage capacity, the plateau pressure in the hydrogen absorption process, and the plateau pressure in the hydrogen desorption process were as shown in Table 3.

TABLE 1

| Alloy | Chemical Composition (molar ratio) | | | | | Chemical Composition (atom %) | | | | | |
|---|---|---|---|---|---|---|---|---|---|---|---|
| No. | Ti | Zr | Ni | Cr | Mn | Ti | Zr | Ni | Cr | Mn | ΔSₘᵢₓ |
| A1 | 0.2 | 0.2 | 0.2 | 0.2 | 0.2 | 20.0 | 20.0 | 20.0 | 20.0 | 20.0 | 1.61R |
| A2 | 0.225 | 0.175 | 0.2 | 0.2 | 0.2 | 22.5 | 17.5 | 20.0 | 20.0 | 20.0 | 1.61R |
| A3 | 0.25 | 0.15 | 0.2 | 0.2 | 0.2 | 25.0 | 15.0 | 20.0 | 20.0 | 20.0 | 1.59R |
| A4 | 0.2 | 0.2 | 0.25 | 0.15 | 0.15 | 21.1 | 21.1 | 26.3 | 15.8 | 15.8 | 1.59R |
| A5 | 0.2 | 0.2 | 0.25 | 0.2 | 0.2 | 19.0 | 19.0 | 23.8 | 19.0 | 19.0 | 1.61R |
| A6 | 0.2 | 0.2 | 0.2 | 0.2 | 0.175 | 20.5 | 20.5 | 20.5 | 20.5 | 17.9 | 1.60R |
| A7 | 0.2 | 0.2 | 0.2 | 0.225 | 0.175 | 20.0 | 20.0 | 20.0 | 22.5 | 17.5 | 1.60R |
| A8 | 0.2 | 0.2 | 0.2 | 0.225 | 0.15 | 20.5 | 20.5 | 20.5 | 23.1 | 15.4 | 1.60R |
| A9 | 0.2 | 0.2 | 0.275 | 0.2 | 0.2 | 18.6 | 18.6 | 25.6 | 18.6 | 18.6 | 1.60R |
| A10 | 0.2 | 0.2 | 0.3 | 0.2 | 0.2 | 18.2 | 18.2 | 27.3 | 18.2 | 18.2 | 1.59R |
| A11 | 0.2 | 0.2 | 0.325 | 0.2 | 0.2 | 17.8 | 17.8 | 28.9 | 17.8 | 17.8 | 1.59R |
| A12 | 0.2 | 0.2 | 0.225 | 0.2 | 0.2 | 19.5 | 19.5 | 22.0 | 19.5 | 19.5 | 1.60R |
| A13 | 0.2 | 0.2 | 0.28 | 0.2 | 0.2 | 18.5 | 18.5 | 25.9 | 18.5 | 18.5 | 1.59R |
| A14 | 0.2 | 0.2 | 0.29 | 0.2 | 0.2 | 18.3 | 18.3 | 26.6 | 18.3 | 18.3 | 1.59R |
| A15 | 0.15 | 0.25 | 0.25 | 0.2 | 0.2 | 14.3 | 23.8 | 23.8 | 19.0 | 19.0 | 1.61R |
| A16 | 0.25 | 0.15 | 0.25 | 0.2 | 0.2 | 23.8 | 14.3 | 23.8 | 19.0 | 19.0 | 1.61R |

TABLE 2

| | Main Phase | | Second Phase | | | | |
|---|---|---|---|---|---|---|---|
| | | Constituent | | Constituent | Lattice Constant | | Lattice Volume |
| Alloy | Crystal | Ratio | Crystal | Ratio | of Main Phase | | of Main Phase |
| No. | Structure | (mass %) | Structure | (mass %) | a(Å) | c(Å) | (Å³) |
| A1 | ZrMn₂ | 96.9 | Ti_{0.64}Zr_{0.36}Ni | 3.1 | 5.00 | 8.20 | 177.53 |
| | (C14 type) | | (B2 type) | | | | |
| A2 | ZrMn₂ | 84.7 | Ti_{0.64}Zr_{0.36}Ni | 15.3 | 4.98 | 8.16 | 175.25 |
| | (C14 type) | | (B2 type) | | | | |
| A3 | ZrMn₂ | 84.3 | Ti_{0.64}Zr_{0.36}Ni | 15.7 | 4.97 | 8.14 | 174.12 |
| | (C14 type) | | (B2 type) | | | | |
| A4 | ZrMn₂ | 96.4 | Ti_{0.64}Zr_{0.36}Ni | 3.6 | 4.98 | 8.13 | 174.61 |
| | (C14 type) | | (B2 type) | | | | |
| A5 | ZrMn₂ | 84.1 | Ti_{0.64}Zr_{0.36}Ni | 15.9 | 4.99 | 8.17 | 176.17 |
| | (C14 type) | | (B2 type) | | | | |
| A6 | ZrMn₂ | 97.6 | Ti_{0.64}Zr_{0.36}Ni | 2.4 | 5.00 | 8.18 | 177.10 |
| | (C14 type) | | (B2 type) | | | | |
| A7 | ZrMn₂ | 94.3 | Ti_{0.64}Zr_{0.36}Ni | 5.7 | 4.99 | 8.18 | 176.39 |
| | (C14 type) | | (B2 type) | | | | |
| A8 | ZrMn₂ | 92.7 | Ti_{0.64}Zr_{0.36}Ni | 7.3 | 4.99 | 8.18 | 176.39 |
| | (C14 type) | | (B2 type) | | | | |
| A9 | ZrMn₂ | 87.6 | Ti_{0.64}Zr_{0.36}Ni | 12.4 | 4.97 | 8.11 | 173.48 |
| | (C14 type) | | (B2 type) | | | | |
| A10 | ZrMn₂ | 85.4 | Ti_{0.64}Zr_{0.36}Ni | 14.6 | 4.96 | 8.10 | 172.57 |
| | (C14 typc) | | (B2 type) | | | | |
| A11 | ZrMn₂ | 86.0 | Ti_{0.64}Zr_{0.36}Ni | 14.0 | 4.95 | 8.07 | 171.24 |
| | (C14 type) | | (B2 type) | | | | |
| A12 | ZrMn₂ | 91.9 | Ti_{0.64}Zr_{0.36}Ni | 8.1 | 4.99 | 8.18 | 176.42 |
| | (C14 type) | | (B2 type) | | | | |
| A13 | ZrMn₂ | 85.3 | Ti_{0.64}Zr_{0.36}Ni | 14.7 | 4.96 | 8.11 | 172.71 |
| | (C14 type) | | (B2 type) | | | | |
| A14 | ZrMn₂ | 85.3 | Ti_{0.64}Zr_{0.36}Ni | 14.7 | 4.95 | 8.10 | 172.61 |
| | (C14 type) | | (B2 type) | | | | |
| A15 | ZrMn₂ | 70.9 | Ti_{0.64}Zr_{0.36}Ni | 29.1 | 5.03 | 8.23 | 180.19 |
| | (C14 type) | | (B2 type) | | | | |
| A16 | ZrMn₂ | 78.7 | Ti_{0.64}Zr_{0.36}Ni | 21.3 | 4.87 | 7.97 | 164.21 |
| | (C14 type) | | (B2 type) | | | | |

TABLE 3

| | Maximum Hydrogen | Plateau Pressure (MPa) | |
|---|---|---|---|
| | Storage Capacity | Absorption | Desorption |
| Alloy No. | (mass %) | Process | Process |
| A1 | 1.80 | 0.007 | 0.005 |
| A2 | 1.73 | 0.017 | 0.009 |
| A3 | 1.64 | 0.040 | 0.021 |
| A4 | 1.68 | 0.011 | 0.004 |
| A5 | 1.66 | 0.020 | 0.016 |
| A6 | 1.81 | 0.004 | 0.004 |
| A7 | 1.70 | 0.009 | 0.007 |
| A8 | 1.72 | 0.007 | 0.005 |
| A9 | 1.66 | 0.031 | 0.028 |
| A10 | 1.56 | 0.072 | 0.070 |
| A11 | 1.51 | 0.132 | 0.125 |
| A12 | 1.73 | 0.013 | 0.009 |
| A13 | 1.59 | 0.046 | 0.035 |
| A14 | 1.56 | 0.064 | 0.048 |
| A15 | 1.70 | 0.002 | 0.001 |
| A16 | 0.52 | 0.076 | 0.004 |

As shown in Table 1, the alloys A1 to A16 each have a chemical composition in which the contents of Ti, Zr, Ni, Cr, and Mn respectively fall within the specific ranges described above, and the mixing entropy ΔSₘᵢₓ is 1.5 R or more. As shown in FIG. 1 and Table 2, the crystal structure of the main phase of each of the alloys A1 to A16 is the C14 type. This makes it possible for the alloys A1 to A16 to absorb hydrogen and desorb absorbed hydrogen.

Among these alloys, the alloys A1 to A14 contain a subphase having the B2 type crystal structure. The constituent ratio of the subphase having the B2 type crystal structure is more than 0 mass % and 20 mass % or less. Therefore, the alloys A1 to A14 to have a high hydrogen storage capacity as shown in Table 3 and easily release stored hydrogen even in an ambient temperature environment.

In addition, as shown in FIG. 3 and Table 3, the alloys A1 to A14 can extremely reduce the pressure difference between the plateau pressure in the hydrogen absorption process and the plateau pressure in the hydrogen desorption process, that is, the hysteresis between the hydrogen absorption process and the hydrogen desorption process. Accordingly, these alloys make it possible to control the amount of hydrogen to be supplied to the hydrogen storage alloy in the hydrogen absorption process and the amount of hydrogen to be desorbed from the hydrogen storage alloy in the hydrogen desorption process by the same method, and are excellent in practical use.

### Example 2

In the present example, an example of a negative electrode for an alkaline storage battery using a hydrogen storage alloy as an active material will be described. As illustrated in FIG. 4, a negative electrode 1 for an alkaline storage battery of the present example includes a current collector 2 including a conductor, a binder 3, and a powdery active material 4 held by the current collector 2 via the binder 3. Particles 41 constituting the active material 4 are each composed of a hydrogen storage alloy having a specific chemical composition in which a crystal structure of a main phase is a C14 type. Hereinafter, a method for producing the negative electrode 1 of the present example will be described in detail.

### <Method for Producing Negative Electrode 1 for Alkaline Storage Battery>

First, each of the powdery alloys A1 to A16 obtained in Example 1, a Ni powder, and polyvinyl alcohol (PVA) and carboxymethyl cellulose (CMC) as the binder 3 were mixed at mass ratios of active material 4: Ni powder: PVA: CMC=74:24:0.5:1.5 to prepare a paste-like negative electrode mixture. The negative electrode mixture was filled in a Ni mesh separately prepared as the current collector 2. Thereafter, the Ni mesh was rolled using a roll press to bring the negative electrode mixture into close contact with the Ni mesh. In this way, negative electrodes 1 (test specimens B1 to B16) shown in Table 4 were obtained.

Next, each of the test specimens B1 to B16 was combined with a commercially available Ni(OH)₂/NiOOH positive electrode and a Hg/HgO reference electrode to form a triple-pole battery cell using an electrolyte containing 6 mol/L of potassium hydroxide and 1 mol/L of lithium hydroxide. The charge/discharge and the measurement of the discharge capacity of the battery cell were performed using a potentiostat (VMP3 manufactured by Bio-Logic SAS) to thereby evaluate the maximum discharge capacity and the average operating potential of each test specimen.

### [Maximum Discharge Capacity and Average Operating Potential]

The battery cell was charged for 5 hours under conditions of a temperature of 30° C. and a current density of 25 mA/g, and then the charge was in pause for 10 minutes to stabilize the potential. Then, the battery cell was discharged to a potential of −0.5 V to a potential of Hg/HgO as a reference at a current density of 25 mA/g. This charge and discharge cycle was repeated five times, and preparation for measurement of the maximum discharge capacity and the average operating potential was completed.

The battery cell at the ready was charged for 5 hours under conditions of a temperature of 30° C. and a current density of 25 mA/g, and then the charge was in pause for 10 minutes to stabilize the potential. The battery cell was further discharged to a potential of −0.5 V to a potential of Hg/HgO as a reference at a current density of 100 mA/g to thereby obtain a discharging curve.

The maximum discharge capacity and the average operating potential were calculated on the basis of the discharge curve thus obtained. The maximum discharge capacity shown in Table 4 is a value of the discharge capacity from a discharge starting point to a time point when the potential of the test specimen reached −0.5 V to the potential of Hg/HgO as a reference. The average operating potential shown in Table 4 is a potential value of the test specimen at the time point when the value of the discharge capacity reached ½ of the maximum discharge capacity.

TABLE 4

| | Chemical | Maximum | Average |
|---|---|---|---|
| Test | Composition | Discharge | Operating |
| Specimen | of Active | Capacity | Potential |
| No. | Material | (mAh/g) | (V) |
| B1 | A1 | 247 | −0.867 |
| B2 | A2 | 273 | −0.846 |
| B3 | A3 | 287 | −0.850 |
| B4 | A4 | 195 | −0.841 |
| B5 | A5 | 318 | −0.870 |
| B6 | A6 | 170 | −0.819 |
| B7 | A7 | 237 | −0.807 |
| B8 | A8 | 158 | −0.823 |
| B9 | A9 | 360 | −0.895 |
| B10 | A10 | 337 | −0.902 |
| B11 | A11 | 323 | −0.905 |
| B12 | A12 | 314 | −0.882 |
| B13 | A13 | 358 | −0.898 |
| B14 | A14 | 344 | −0.900 |
| B15 | A15 | 128 | −0.840 |
| B16 | A16 | 131 | −0.903 |

As shown in Table 4, the active material of each of the test specimens B1 to B16 is composed of the hydrogen storage alloy having the specific chemical composition and having the crystal structure of the main phase of the C14 type. Thus, the maximum discharge capacity and the average operating potential at the time of discharge of each of these test specimens were good. Among these test specimens, the test specimens B1 to B14 in which the subphase was a crystal phase having the B2 type crystal structure and the constituent ratio of the subphase was more than 0 mass % and 20 mass % or less had a higher maximum discharge capacity.

The average operating potential of each of the test specimen B5 and the test specimens B9 to B14 was equal to or higher than that of a general AB₅ type hydrogen storage alloy containing a rare earth mixed metal. In addition, the maximum discharge capacity of each of these test specimens was higher than that of the general AB₅ type hydrogen storage alloy containing a rare earth mixed metal.

### Example 3

In the present example, an example of a negative electrode for an alkaline storage battery subjected to activation treatment will be described. In the present example, the test specimen B9 used in Example 2, and a test specimen B1A, a test specimen B5A, and test specimens B9A to B14A obtained by performing the activation treatment on the test specimen B1, the test specimen B5, and the test specimens B9 to B14 were used to evaluate discharge rate properties. A method for preparing the test specimens B1A, B5A, and B9A to B14A is as follows.

First, the test specimens B1, B5, and B9 to B14 were prepared by the method described above, and then these test specimens were subjected to activation treatment of boiling in a 6 mol/L aqueous potassium hydroxide solution for 2 to 4 hours. The temperature of the aqueous potassium hydroxide solution was set to be 105° C. As described above, the test specimens B1A, B5A, and B9A to B14A were obtained. A surface layer (not illustrated) containing a hydroxide of Ni was formed on the surface of each of the particles 41 constituting the active material 4 in these test specimens.

### [Discharge Rate Properties]

For evaluation of the discharge rate properties, the discharge capacity of the battery cell was measured in each of the cases where the value of a current density at a time of discharge is variously changed. Specifically, first, in the same manner as in Example 2, a triple-pole battery cell having any of the test specimens shown in Table 5 as a negative electrode was formed. The battery cell was charged for 5 hours under conditions of a temperature of 30° C. and a current density of 25 mA/g, and then the charge was in pause for 10 minutes to stabilize the potential. Then, the battery cell was discharged to a potential of −0.5 V to the potential of Hg/HgO as a reference at a current density of any of 25 mA/g, 50 mA/g, 100 mA/g, 250 mA/g, 500 mA/g, or 1000 mA/g. Thereafter, the discharge capacity of the battery cell from the start of discharge to the end of discharge was measured.

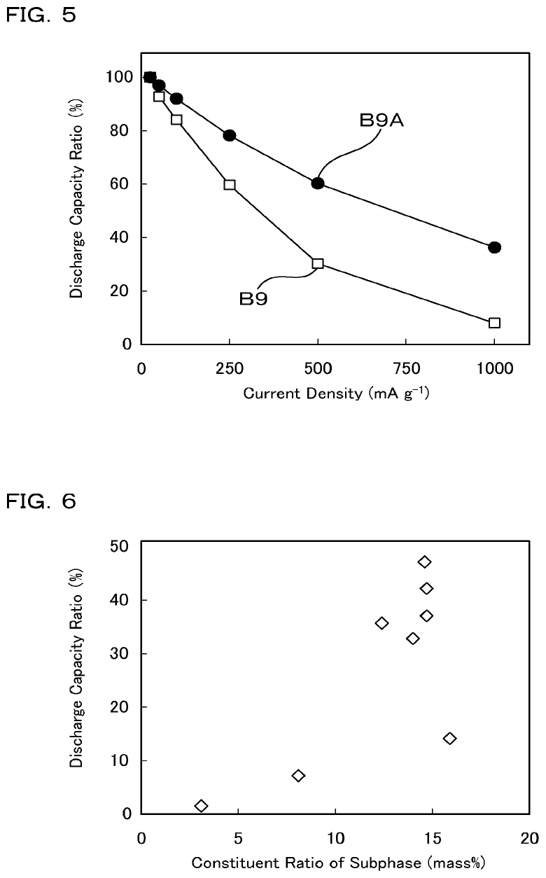

Table 5 shows the discharge capacity and the discharge capacity ratio when performing discharge at each current density. The discharge capacity ratio (unit: %) in Table 5 is a value of the ratio, in percentage terms, of the discharge capacity when the battery cell was discharged at 1000 mA/g to the discharge capacity when the battery cell was discharged at 25 mA/g. FIG. 5 shows, as an example, the discharge rate properties of the test specimen B9 and the test specimen B9A. In FIG. 5, the vertical axis represents the ratio of the discharge capacity at each current density to the discharge capacity at a current density of 25 mA/g in percentage terms (unit:%), and the horizontal axis represents the current density at the time of discharge (unit: mA/g).

Furthermore, FIG. 6 is a graph showing the relationship between the discharge capacity ratios of the test specimens subjected to the activation treatment and the constituent ratios of the subphases having the B2 type crystal structure. In FIG. 6, the vertical axis represents the discharge capacity ratio (unit: %) of each test specimen, and the horizontal axis represents the constituent ratio (unit: mass %) of the subphase of each test specimen.

TABLE 5

| | Chemical | Activation | | | | | | | Discharge |
|---|---|---|---|---|---|---|---|---|---|
| Test | Composition | Treatment | Discharge Capacity (mAh/g) | | | | | | Capacity |
| Specimen | of Active | Performed | 25 | 50 | 100 | 250 | 500 | 1000 | Ratio |
| No. | Material | Not Performed | mA/g | mA/g | mA/g | mA/g | mA/g | mA/g | (%) |
| B9 | A9 | Not Performed | 360 | 334 | 303 | 215 | 109 | 29 | 8 |
| B9A | A9 | Performed | 363 | 351 | 332 | 279 | 208 | 127 | 35 |
| B1A | A1 | Performed | 247 | 193 | 133 | 46 | 15 | 4 | 1 |
| B5A | A5 | Performed | 346 | 324 | 294 | 213 | 124 | 48 | 14 |
| B10A | A10 | Performed | 338 | 322 | 309 | 273 | 224 | 156 | 46 |
| B11A | A11 | Performed | 323 | 305 | 284 | 241 | 190 | 104 | 32 |
| B12A | A12 | Performed | 313 | 278 | 218 | 115 | 56 | 22 | 7 |
| B13A | A13 | Performed | 358 | 341 | 318 | 286 | 214 | 130 | 36 |
| B14A | A14 | Performed | 341 | 320 | 304 | 277 | 218 | 141 | 41 |

As shown in Table 5, the discharge capacity of the test specimen B9A subjected to the activation treatment was higher than that of the test specimen B9 before the activation treatment at any current density. In addition, as shown in FIG. 5, in the test specimen B9A, a decrease in discharge capacity due to an increase in current density can be curtailed as compared with the test specimen B9.

Furthermore, as shown in FIG. 6 and Table 5, among the test specimens subjected to the activation treatment, the test specimens B9A, B10A, B11A, B13A, and B14A in which the content of Ni was 25 atom % or more and 30 atom % or less, and the constituent ratio of the subphase having the B2 type crystal structure was 10 mass % or more and 15 mass % or less had a higher discharge capacity ratio than that of the test specimens other than these, and it was possible to curtail decrease in discharge capacity when discharging at a high current density. As a cause of this, for example, it is considered that an Ni atom or a crystal phase having the B2 type crystal structure exhibits an electrochemical catalytic action.

### Example 4

In the present example, an example in which charge and discharge cycle characteristics of a negative electrode for an alkaline storage battery subjected to activation treatment was evaluated will be described.

### [Charge and Discharge Cycle Properties]

In evaluation of the charge and discharge cycle properties, the test specimen BIA, the test specimen B5A, and the test specimens B9A to B14A prepared by the same method as in Example 3 were used to measure the discharge capacity when a charge and discharge cycle was repeated 30 times. Specifically, first, in the same manner as in Example 2, a triple-pole battery cell having any of the test specimens shown in Table 6 as a negative electrode was formed. The battery cell was charged for 5 hours under conditions of a temperature of 30° C. and a current density of 100 mA/g, and then the charge was in pause for 10 minutes to stabilize the potential. Then, the battery cell was discharged to a potential of −0.5 V to a potential of Hg/HgO as a reference at a current density of 100 mA/g. Thereafter, the discharge capacity of the battery cell from the start of discharge to the end of discharge was measured. This operation was repeated 30 times.

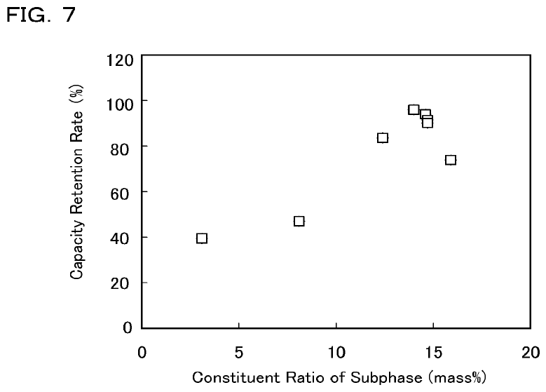

Table 6 shows the discharge capacity in the first charge and discharge cycle, the discharge capacity after 30 cycles, and the capacity retention rate. The capacity retention rate (unit: %) in Table 6 is a value obtained by expressing the ratio of the discharge capacity after 30 cycles to the discharge capacity in the first charge and discharge cycle in percentage terms. FIG. 7 is a graph showing a relationship between a capacity retention rate and a constituent ratio of a subphase of each test specimen. In FIG. 7, the vertical axis represents the capacity retention rate (unit: %), and the horizontal axis represents the constituent ratio (unit: mass %) of the subphase.

TABLE 6

| | Chemical | Activation | Discharge | | Capacity |
|---|---|---|---|---|---|
| Test | Composition | Treatment | Capacity (mAh/g) | | Retention |
| Specimen | of Active | Performed or | Initial | After 30 | Rate |
| No. | Material | Not Performed | Stage | Cycles | (%) |
| B1A | A1 | Performed | 162 | 64 | 40 |
| B5A | A5 | Performed | 295 | 218 | 74 |
| B9A | A9 | Performed | 324 | 271 | 84 |
| B10A | A10 | Performed | 284 | 267 | 94 |
| B11A | A11 | Performed | 277 | 266 | 96 |
| B12A | A12 | Performed | 255 | 120 | 47 |
| B13A | A13 | Performed | 306 | 280 | 92 |
| B14A | A14 | Performed | 292 | 263 | 90 |

As shown in FIG. 7 and Table 6, among the test specimens subjected to the activation treatment, the test specimens B9A, B10A, B11A, B13A, and B14A in which the content of Ni was 25 atom % or more and 30 atom % or less, and the constituent ratio of the subphase having the B2 type crystal structure was 10 mass % or more and 15 mass % or less had a higher capacity retention rate than that of the test specimens other than these, and it was possible to curtail decrease in discharge capacity when the charge and discharge cycle was repeated. As a cause of this, for example, it is considered that the hydrogen storage capacity of the hydrogen storage alloy used in these test specimens was appropriately low and the expansion amount and the contraction amount of the hydrogen storage alloy due to the absorption and desorption of hydrogen were small, and thus the hydrogen storage alloy was less broken, or the amounts of elements other than Ni were relatively small, and thus elution amounts of these elements were reduced.

Specific aspects of the hydrogen storage alloy, the negative electrode for an alkaline storage battery, and the alkaline storage battery according to the present invention are not limited to the aspects described in Examples 1 to 4, and can be appropriately changed without impairing the gist of the present invention.

1. A high-entropy hydrogen storage alloy comprising:
Ti: 5 atom % or more and 35 atom % or less;
Zr: 5 atom % or more and 35 atom % or less;
Ni: 5 atom % or more and 35 atom % or less;
Cr: 5 atom % or more and 35 atom % or less; and
Mn: 5 atom % or more and 35 atom % or less, wherein
a mixing entropy ΔSₘᵢₓ represented by the following formula (1) is 1.5 R or more and
a crystal structure of a main phase is C14 type:
$$\begin{matrix}[ Math . 1 ] & \\ Δ {S}_{m i x} = - R {\sum }_{i = T i , Zr , Ni , Cr , Mn} {x}_{i} ln {x}_{i} & ( 1 )\end{matrix}$$
wherein R in the formula (1) represents the gas constant, and xᵢ represents a molar fraction of each element contained in the high-entropy hydrogen storage alloy.

2. The high-entropy hydrogen storage alloy according to claim 1, further comprising a subphase having a B2 type crystal structure, wherein a constituent ratio of the subphase is more than 0 mass % and 20 mass % or less.

3. The high-entropy hydrogen storage alloy according to claim 2, wherein the constituent ratio of the subphase is 10 mass % or more and 16 mass % or less.

4. A negative electrode for an alkaline storage battery, the negative electrode comprising: a current collector including a conductor; a binder; and a powdery active material and held by the current collector via the binder, wherein
the active material includes a core portion composed of the high-entropy hydrogen storage alloy according to claim 1, and
a surface layer containing a hydroxide of Ni and existing on a surface of the core portion.

5. An alkaline storage battery comprising the negative electrode for an alkaline storage battery according to claim 4.

6. A negative electrode for an alkaline storage battery, the negative electrode comprising: a current collector including a conductor; a binder; and a powdery active material and held by the current collector via the binder, wherein
the active material includes a core portion composed of the high-entropy hydrogen storage alloy according to claim 2, and
a surface layer containing a hydroxide of Ni and existing on a surface of the core portion.

7. A negative electrode for an alkaline storage battery, the negative electrode comprising: a current collector including a conductor; a binder; and a powdery active material and held by the current collector via the binder, wherein
the active material includes
a core portion composed of the high-entropy hydrogen storage alloy according to claim 3, and
a surface layer containing a hydroxide of Ni and existing on a surface of the core portion.

8. An alkaline storage battery comprising the negative electrode for an alkaline storage battery according to claim 6.

9. An alkaline storage battery comprising the negative electrode for an alkaline storage battery according to claim 7.
